(19) United States
(12) Patent Application Publication
(10) Pub. No.: US 2008/0185262 A1
(43) Pub. Date: Aug. 7, 2008

(54) BANKNOTE VALIDATION

(75) Inventors: Peter Dunlop, Oldham (GB); Martin Sackfield, Oldham (GB)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: INNOVATIVE TECHNOLOGY LIMITED, Oldham (GB)

(21) Appl. No.: 12/024,334

(22) Filed: Feb. 1, 2008

(30) Foreign Application Priority Data
Feb. 5, 2007 (GB) 0702191.8

(51) Int. Cl. G07F 7/04

(52) U.S. Cl. 194/207; 194/206

(57) ABSTRACT

The invention relates to apparatus which allows the validation of banknotes to be performed. The apparatus includes a housing having a banknote receiving portion and a banknote acceptance portion and a banknote path formed through said portions. The banknote receiving portion and the banknote acceptance portion include seamless banknote aligning means forming the banknote path, so as to align the banknotes in use. The apparatus can also include a circuit board comprising the banknote sensing and validation means and the banknote path is arranged to intersect a major plane of the circuit board.

### BACKGROUND OF THE INVENTION

This invention concerns improvements relating to banknote validation and more specifically relates to the handling and validating of flexible sheets of monetary value, such as banknotes, handled by systems such as vending machines, gaming machines, payment machines and banknote dispensers.

For convenience, banknotes will be used as an example of such sheets throughout this specification. The term banknote will also be used to encompass other items of money's worth that have detectable features requiring validation, such as tickets and vouchers.

A machine that receives and handles banknotes typically includes a validator that verifies a banknote upon insertion by checking its authenticity and condition and rejecting it if it is deemed invalid. An example of a validator is disclosed in the applicant's International Patent Application WO03/012747. Once validated, the banknote typically passes from the validator into a secure long-term store, such as a removable cassette-type stacker or a cashbox within the machine. Once in a long-term store, a validator banknote typically cannot be removed by, or dispensed to, the user: it can only be removed from the machine when, for example, the stacker is replaced or the cashbox is emptied by an authorised person maintaining or servicing the machine.

A banknote validator comprises numerous functional components. Thus, a housing usually defines at least part of a banknote path beginning, upstream, with a slot through which a banknote is inserted and ending, downstream, at an output typically leading to a secure long-term store in which the banknotes are stacked. Upon sensing insertion of a banknote, a drive mechanism inside the validator is activated, drawing the banknote into the validator via the slot, and past sensors that determine certain characteristics, such as the validity, of the banknote. If the banknote is deemed to be valid, it is guided downstream by the drive mechanism along the banknote path and, via the output, into the secure long-term store. Otherwise, if the banknote is deemed invalid, the drive mechanism is usually reversed and the banknote is returned upstream to the user. One or more “anti-stringing” features, as described for example in our European Patent EP0940778 may be provided to prevent users from defrauding the validator.

A drive mechanism typically comprises several pairs of wheels or rollers that co-operate to grip and transport the banknote along the banknote path in use. The rollers in each pair are located adjacent each other and are driven by a motor. Either both rollers in each pair are motorised or only one roller is motorised. In the latter case, the second roller in the pair is a ‘reaction’ roller or idler wheel that rotates in response to rotation of the motorised roller. Also it is possible for the drive mechanism to comprise one or more flexible toothed belts mounted on spaced apart driven wheels or rollers.

The sensors of a validator may, for example, comprise light sources, such as light emitting diodes (LEDs) that illuminate the banknote at particular wavelengths, and light receivers to receive the light transmitted through or reflected from the banknote. The magnetic signature of a banknote may also be sensed by suitable magnetic sensors. The characteristics of the banknote are then compared with expected characteristics for a valid banknote to determine whether or not the banknote under test is valid.

In order to allow smooth running and maintenance of banknote validators, it is important for functional components such as the banknote path, the drive mechanism and the sensors to be accessible. For example, it is often necessary to clear a jammed banknote in the banknote path, to repair or service the drive mechanism, for example to change a worn belt, and to clean or replace the sensors. Thus, referring again to WO03/012747 and EP0940778, it is common for validators to comprise separable housing portions which are parted longitudinally along the banknote path such that a seam is present along the walls defining the banknote path.

There is a continuous commercial pressure for banknote validators to become on the one hand more reliable and efficient, and on the other hand cheaper to produce. However, there is traditionally a trade-off between these attributes since enhanced reliability, such as a reduction in jamming or an increase in the reliability of banknote validation, is generally attributable to more expensive components.

There is thus a need for a banknote validator which can be produced inexpensively but which is nevertheless reliable and effective.

### SUMMARY OF THE INVENTION

Against this background, and according to a first aspect, the present invention broadly resides in: a banknote validator comprising; a housing having a banknote receiving portion and a banknote acceptance portion; and a banknote path, formed through said portions with said banknote receiving portion defining an upstream section of the banknote path, and the banknote acceptance portion defining a downstream section of the banknote path and wherein the banknote receiving portion and the banknote acceptance portion include seamless banknote guide means forming the banknote path in the respective portions.

The banknote validator according to the first aspect of the invention is simple in design and can be produced inexpensively. At the same time it is reliable and effective. It provides for an unprecedented level of design flexibility, for example in the distribution and replacement of banknote validator components, which are generally arranged consecutively, i.e. upstream or downstream of each other, along the banknote path. In the validator according to the first aspect of the invention, such consecutively arranged components can be separated from each other as desired, by distributing them appropriately between the banknote acceptance portion and the banknote receiving portion of the housing. For instance, components may be distributed such that either the banknote receiving portion or the banknote acceptance portion is advantageously cheap to replace.

Since the housing of the banknote validator according to the first aspect of the invention comprises banknote receiving and acceptance portions that respectively define an upstream and a downstream section of the banknote path, the housing does not separate longitudinally along the banknote path like prior art housings. Following extensive experiments and investigations into the reasons for note jamming in banknote validators, the inventors have realised that seams that extend longitudinally along the banknote path between separable housing portions in prior art validators can act as catches for the edges of banknotes and hence cause banknote jams, particularly during the initial alignment of banknotes within the banknote path. The structure of the banknote validator according to the first aspect of the invention enables seams extending longitudinally along the banknote path to be avoided, without compromising the substantial benefits (e.g. accessibility), afforded by separable housing portions.

Preferably, to minimise banknote jams, the banknote receiving portion may comprise seamless banknote aligning means provided at elongate edges of the upstream section of the banknote path, for aligning banknotes in use. The presence of seams, irrespective of their direction, can thus be avoided entirely in the banknote aligning means, making banknote jams far less likely to occur during the key phase of banknote alignment. The banknote aligning means may conveniently comprise a receiving tube, which may optionally have an interlocking formation for engaging a complementary interlocking formation in the banknote acceptance portion. An interlocking formation is particularly beneficial in the receiving tube when the banknote acceptance portion comprises a banknote acceptance tube with a complementary interlocking formation and the banknote receiving tube and the banknote acceptance tube combine to define the banknote path as a whole.

Advantageously, the banknote receiving portion may comprise an input slot and means for gripping and aligning banknotes inserted into the banknote path via said input slot. In a particularly advantageous configuration, the means for gripping and aligning banknotes comprise: driving means positioned centrally with respect to a length of the input slot for pivotally gripping and conveying banknotes along the banknote path; and seamless banknote aligning means provided at elongate edges of the banknote path for aligning pivotally gripped banknotes within the banknote path. There is a synergy between the centrally positioned driving means and the seamless banknote aligning means: they interact to align banknotes correctly in the banknote path in use, before they can make significant downstream progress, whilst minimising banknote jams. Any misalignment of a banknote is corrected by the seamless aligning means exerting a correcting force on the banknote and the pivoting movement of the banknote about the centrally positioned driving means. It is particularly preferred that the alignment means used in combination with the centrally positioned drive means are seamless because pivotally gripped and conveyed banknotes have been found to be particularly prone to jamming prior art banknote validators comprising alignment means having seams, especially seams extending longitudinally along the banknote path.

Conveniently, the driving means may comprise a pair of driven wheels. At least one of the driven wheels may advantageously be driven by a motor located in the banknote acceptance portion. This is an example of the flexible component distribution enabled by the banknote validator according to the first aspect of the invention: where at least one wheel is driven by a motor located in the banknote acceptance portion, there is no need for a motor in the banknote receiving portion, which is therefore cheaper to replace if necessary. Preferably, only one of the wheels is driven and the other wheel is a reaction wheel.

Conveniently, the banknote receiving portion may comprise a cut out at the upstream section of the banknote path for allowing the driving means to access the banknote path.

The banknote acceptance portion may advantageously comprise banknote conveying means and banknote sensing means. The provision of these components in the banknote acceptance portion enables the banknote receiving portion to be built and replaced at low cost where desired. The banknote conveying means may preferably comprise a drive means for gripping and conveying banknotes and a motor for driving the drive means.

To ensure that banknotes remain aligned within the banknote path, the banknote acceptance portion may comprise banknote guide means provided at elongate edges of the downstream section of the banknote path for guiding banknotes in use. It is particularly preferred that the banknote guide means are seamless so that banknote jams in the downstream section can be minimised. Conveniently, the seamless banknote guide means may comprise an acceptance tube, which may optionally have an interlocking formation for engaging a complementary interlocking formation in the banknote receiving portion (most preferably for engaging an interlocking formation in a banknote receiving tube of the banknote receiving portion, as described above).

The banknote guide means may optionally be arranged to act as an optical element for conveying light from a light source into the banknote path to illuminate a banknote in use. Additionally or alternatively, the banknote guide means may be arranged to act as an optical element for conveying light from the banknote path to a light sensor. To enable them to convey light effectively, the banknote guide means may advantageously comprise a translucent plastics material or be entirely comprised of a translucent plastics material. Thus, the banknote guide means can perform a role in conveying sensory light for validating banknotes in the banknote path.

Where the banknote guide means are arranged to act as an optical element, a seamless structure is particularly beneficial. For instance, it is much easier to calibrate optical sensors acting via a seamless optical element because light paths remain constant. To provide for a seamless structure, the banknote guide means may conveniently comprise an acceptance tube that surrounds the banknote path and is arranged to transmit light across the banknote path. This has the advantage of allowing the banknote validator to operate with only a single optical element, in the form of the banknote guide means that simultaneously act to guide banknotes along the banknote path. The banknote validator is hence rendered more compact and cheaper to manufacture than prior art validators. The acceptance tube may optionally comprise a cut-out for accommodating a drive means.

The banknote validator according to the first aspect of the invention may comprise a circuit board which works in synergy with the banknote guide means. The circuit board may include a validity LED/sensor pair for sensing the validity of banknotes in the banknote path, and the banknote guide means may define a validation light path between an LED and a sensor of the validity LED/sensor pair, the validation light path intersecting with the banknote path. Banknotes in the banknote path can then be validated by the circuit board by analysing the flow of light between the validity LED and the validity sensor. Preferably, the banknote guide means may comprise one or more integral optical formations for guiding light along the validation light path. In a particularly preferred embodiment, the LED and the sensor of the validity LED/sensor pair are both located on a single major surface of the circuit board, and the integral optical formations of the banknote guide means comprise a plurality of prisms for steering light from the LED of the validity LED/sensor pair, across the banknote path, to the sensor of the validity LED/sensor pair. Location of both the LED and the sensor on a single major surface of the circuit board simplifies the manufacture of the circuit board significantly, thereby lowering cost. To enhance the accuracy of validity sensing, the integral optical formations of the banknote guide means may further comprise a collecting lens for focussing light on the sensor of the validity LED/sensor pair.

Advantageously, the circuit board may additionally or alternatively comprise an insertion LED/sensor pair for sensing the insertion of banknotes into the banknote validator, and the banknote guide means may define an insertion light path between an LED and a sensor of the insertion LED/sensor pair, the insertion light path intersecting with the banknote path. The insertion of the banknotes can then be detected by the circuit board by analysing the flow of light between the insertion LED and the insertion sensor. Preferably, the banknote guide means may comprise one or more integral optical formations for guiding light along the insertion light path. Advantageously, to lower manufacturing costs, and LED and the sensor of the insertion LED/sensor paid may both be located on a single major surface of the circuit board and the integral optical formations of the banknote guide means may comprise a plurality of prisms for steering light from the LED of the insertion LED/sensor pair, across the banknote path, to the sensor of the insertion LED/sensor pair.

In order to allow the insertion LED/sensor pair to sense the insertion of banknotes at an early stage, the banknote guide means may comprise an insertion light guide which steers light from the LED of the insertion LED/sensor pair, across the upstream section of the banknote path defined by the banknote receiving portion of the validator, to the sensor of the insertion LED/sensor pair. Most preferably, the banknote receiving portion of the validator may comprise an input slot and drive means for gripping and transporting banknotes inserted into the banknote path via said input slot, and the insertion light guide may be arranged to steer light across the upstream section of the banknote path at a position between the drive means and the input slot. In this way the insertion of a banknote via the input slot can be sensed before the banknote reaches the drive means, advantageously allowing the drive means to be activated before the note reaches them. To enable the insertion light path to be defined across an appropriately upstream region of the banknote path, the insertion light guide may conveniently comprise a light transmitting arm and a light receiving arm, which arms may be arranged to cooperate with the banknote receiving portion (preferably a banknote acceptance tube of the receiving portion). To enhance the accuracy of insertion sensing, the integral optical formations may further comprise a collecting lens for focussing light on the sensor of the insertion LED/sensor pair.

Typically the circuit board is arranged so that its planar surfaces lie substantially perpendicular to the path of movement of the banknote. In on embodiment the banknote passes through an aperture in the circuit board.

To protect the banknote validator against fraud, the circuit board may additionally or alternatively comprise an anti-stringing LED/sensor pair for detecting stringing; and the banknote guide means may define an anti-stringing light path between an LED and a sensor of the anti-stringing LED/sensor pair, the anti-stringing light path intersecting with the banknote path. An attempt to defraud the validator can then be detected by the circuit board by analysing the flow of light between the LED and the sensor of the anti-stringing LED/sensor pair. Where the banknote guide means defines both a validation light path and an anti-stringing light path, the validation light path and the anti-stringing light path may preferably be oriented transversely with respect to each other within the banknote path. To enhance the accuracy of the anti-stringing sensing, the banknote guide means may further comprise a collecting lens for focussing light on the sensor of the anti-stringing LED/sensor pair.

The circuit board may comprise one or more validity LED/sensor pairs and/or more anti-stinging LED/sensor pairs, with the banknote guide means providing all requisite light paths. Most preferably, all light based sensory functions of the validator are routed via the banknote guide means, as this leads to a particularly compact and cost effective design of the banknote validator.

The banknote acceptance portion and the banknote receiving portion may preferably be pivotably attached to each other and/or may optionally be removably attached to each other. Removable attachment has the advantage that the portions can be replaced independently, which is particularly beneficial considering the flexibility of component distribution afforded by the banknote validator according to the first aspect of the invention. Advantageously, the banknote acceptance portion and the banknote receiving portion may comprise complementary interlocking moulded formations for releasably interlocking the banknote acceptance portion and the banknote receiving portion.

In a second aspect of the invention there is provided a banknote validator comprising: a housing; a banknote path; and a circuit board comprises banknote sensing means; wherein the banknote path is arranged to intersect a major plane of the circuit board.

The banknote validator according to the second aspect of the invention opens up a new area of banknote validator design, where the circuit board is not required to lie with its major (component bearing) surfaces lying parallel to the banknote path as in the prior art.

In prior art validators, where one or more circuit boards lie with their major surfaces parallel to the banknote path, the banknote path can never be shorter than the width of the longest circuit board in plan. However, the validator according to the second aspect of the invention, in which the banknote path is arranged to intersect a major plane of the circuit board (or, in other words, where the circuit board is mounted at an intersecting angle, for example transversely to the banknote path), is of a fundamentally more compact design because it can eliminate the size of the circuit board as a determining factor in the length of the banknote path. A short banknote path, which is enabled in the banknote validator according to the second aspect of the invention, has a number of advantages allowing, for instance, a validator with a reduced depth. Reliability is also increased: the shorter a banknote path, the less likely there are to be banknote jams.

For economy of space, the circuit board may preferably be substantially perpendicular to the banknote path. Additionally or alternatively the circuit board may comprise a recess such as an aperture, and the banknote path may pass through the recess. An aperture has the specific advantage that the banknote path can pass through the circuit board centrally, which leads to further economy of space. Additionally, an aperture provides the opportunity for circuit board components to surround the banknote path.

If the circuit board includes an aperture or recess, the circuit board may advantageously further comprise banknote sensing means that are arranged to operate across the recess; and the banknote validator may further comprise an optical element, which is arranged to cooperate with the recess of the circuit board.

To enable the banknote validator to determine the validity of banknotes, the banknote sensing means may comprise a validity LED/sensor pair which is mounted on a single major surface of the circuit board. Additionally or alternatively, the banknote sensing means may comprise an insertion LED/sensor pair which is mounted on a single major surface of the circuit board, for sensing the insertion of banknotes into the banknote validator. The banknote sensing means may also optionally comprise an anti-stringing LED/sensor pair which is mounted on a single major surface of the circuit board.

The optical element of the banknote validator according to the second aspect of the invention may advantageously comprise a plurality of optical formations and define a light path between an LED and a sensor of at least one LED/sensor pair, said light path intersecting the banknote path. Most preferably, the optical element may provide light paths for all optical sensory functions of the banknote validator, making additional optical elements unnecessary. Thus the optical element may preferably define a light path between an LED and a sensor of the or each LED/sensor pair of the circuit board, the or each light path intersecting the banknotes path.

The circuit board may preferably be perpendicular to the banknote path and the optical formations may comprise a plurality of integral right-angled prisms for defining a light path between an LED and a sensor of at least one LED/sensor pair. The majority of optical banknote sensors perform best when they act on banknotes orthogonally. Therefore, the optical formations are ideally arranged such that at least one light path between an LED and a sensor of at least one LED/sensor pair intersects and banknote path orthogonally with respect to a majority surface of banknotes travelling therein in use.

To enhance the accuracy of the banknote sensing means, the optical formations may comprise a light collecting lens for focussing light on a sensor of an LED/sensor pair.

The banknote validator according to the second aspect of the invention can optionally be made particularly compact if the optical element is arranged to perform a secondary function of guiding banknotes along the banknote path. The optical element may thus conveniently comprise a tube which defines the banknote path.

The sensing means of the circuit board may perform a variety of functions. Thus, the circuit board may comprise insertion sensing means and the optical element may define at least a part of a light path for the insertion sensing means. Additionally or alternatively the circuit board may comprise validity sensing means and the optical element may define at least a part of a light path for the validity sensing means. The circuit board may also comprise anti-stringing sensing means and the optical element may define at least a part of a light path for the anti-stringing sensing means.

In order to minimise the manufacturing cost of the circuit board, the circuit board may preferably comprise an LED and a sensor that both face in a first direction, and the optical element may define a light path from the LED to the sensor, via the banknote path. Ideally all LEDs and sensors on the circuit board may be mounted on a single major surface of the circuit board and, optionally face in a single direction. The circuit board preferably comprises a logic circuit for controlling a drive mechanism of the banknote validator based on the output of the sensing means.

From a third aspect, the invention broadly resides in a banknote validator comprising a banknote path and an optical element for sensing the validity of a banknote, wherein the banknote path passes through an aperture in the optical element.

The optical element may preferably be comprised of a translucent plastics material and be of a seamless moulded construction. This has the advantage of reduced manufacturing costs and enables effective calibration of the sensing function of the banknote validator because there are not seams that could vary the behaviour of light within the optical element.

Advantageously, the optical element may comprise a plurality of integral optical formations such as prisms, collecting lenses, transmitting lenses or light channels.

The integral optical formations may define at least one banknote validity sensing light paths that intersects the banknote path, and may optionally comprise a transmitting prism for guiding light from a validity light source into the banknote path, and a receiving prism for guiding light from the banknote path to a validity sensor. To enhance banknote validity sensing accuracy, the optical formations may further comprise a collecting lens for focussing light on the validity sensor. Most preferably, the optical formations may define a plurality of parallel banknote validity sensing light paths that each intersect the banknote path. In this way the validity of a banknote path can be simultaneously assessed at multiple locations.

The optical formations may advantageously also define an insertion sensing light path that intersects the banknote path and may optionally comprise a transmitting arm for guiding light from an insertion light source into an upstream region of the banknote path, and a receiving arm for guiding light from the upstream region of the banknote path to an insertion sensor.

To enhance the security of the validator, the optical formations may preferably define an anti-stringing light path that intersects the banknote path. Where the optical formations simultaneously define a validity sensing light path, the anti-stringing light path and the validity sensing light path may be oriented transversely with respect to each other in the banknote path.

From a fourth aspect, the invention resides in a bezel for use with a banknote validator, the bezel comprising a banknote receiving slot for receiving a banknote within the banknote validator in use, a single pair of banknote gripping wheels positioned centrally along the slot to enable pivoting movement of the received banknote in use, and at least one seamless guide surface for aligning the pivoted banknotes within the slot.

The bezel of the invention can align banknotes before they proceed downstream into the banknote validitor to be validated. Alignment of banknotes is a prerequisite in for the core functions of a banknote validator, such as validity sensing, to be performed accurately. If banknotes are not aligned correctly then they cannot be validated effectively. Furthermore, alignment of banknotes is important in the context of ensuring that that banknote jams are minimised. Unaligned banknotes are more likely to get caught within the validator, leading to expensive down time. This is avoided by the bezel according to the fourth aspect of the invention, which aligns banknotes at the outset of their passage through a banknote validator, namely in the region of the input slot.

The mechanism of alignment is based on the realisation that there is a synergy between: a single pair of gripping wheels positioned centrally to enable pivoting movement of a banknote, and at least one seamless guide surface for aligning the pivoted banknote. Any misalignment of the banknote is corrected by the seamless guide surface, which causes pivoting movement of the banknote about the centrally positioned gripping wheels. It is important that the guide surface is seamless because pivotally gripped and conveyed banknotes have been found to be particularly prone to jamming prior art banknotes validators comprising alignment means having seams, especially seams extending longitudinally along the banknote path.

Preferably, the wheels and the guide surface are arranged such that a correcting force is exerted on misaligned banknotes. The correcting force can align the misaligned banknotes because they are pivotable about the single pair of banknote griping wheels.

Conveniently, the guide surface may be a tube. To enable simple and cost effective manufacture, the bezel may advantageously be comprised of a moulded plastics material and the tube may be a moulded formation of the bezel.

At least one of the wheels may be driven, and the bezel may preferably comprise a gearing mechanism to enable an external motor to drive at least one of the wheels.

Conveniently, the bezel may comprise cooperating means for cooperating with the validator to enable separable fitting thereto. The cooperating means may for example comprise a hinge and/or a catch portion for cooperating with a complementary latch portion on the validator.

### BRIEF DESCRIPTION OF THE DRAWINGS

In order that this invention may be more readily understood, reference will now be made, by way of example, to the accompanying drawings in which:

FIG. 1 is a front perspective view of a banknote validator according to the invention in an open position;

FIG. 2 is a rear perspective view of the banknote validator of FIG. 1 in an open position;

FIG. 3 is a rear perspective view of a banknote receiving portion of the banknote validator of FIG. 1;

FIG. 4 is a front perspective view of a banknote acceptance portion of the banknote validator of FIG. 1;

FIG. 5a is a rear perspective view of a circuit board and a banknote acceptance channel of the banknote validator of FIG. 1, in isolation;

FIG. 5b is a side perspective view of the circuit board and banknote acceptance channel of FIG. 5a;

FIG. 6 is a rear view of the circuit board of FIGS. 5a and 5b;

FIG. 7 is a front perspective view of the banknote validator of FIG. 1 in a closed position;

FIG. 7b is a front perspective view of the banknote validator of FIG. 1 in a closed position, with a removable power supply unit; and

FIG. 7c is a rear perspective view of the banknote validator of FIG. 1 in a closed position.

### DETAILED DESCRIPTION OF THE PREFERRED EMBODIMENTS

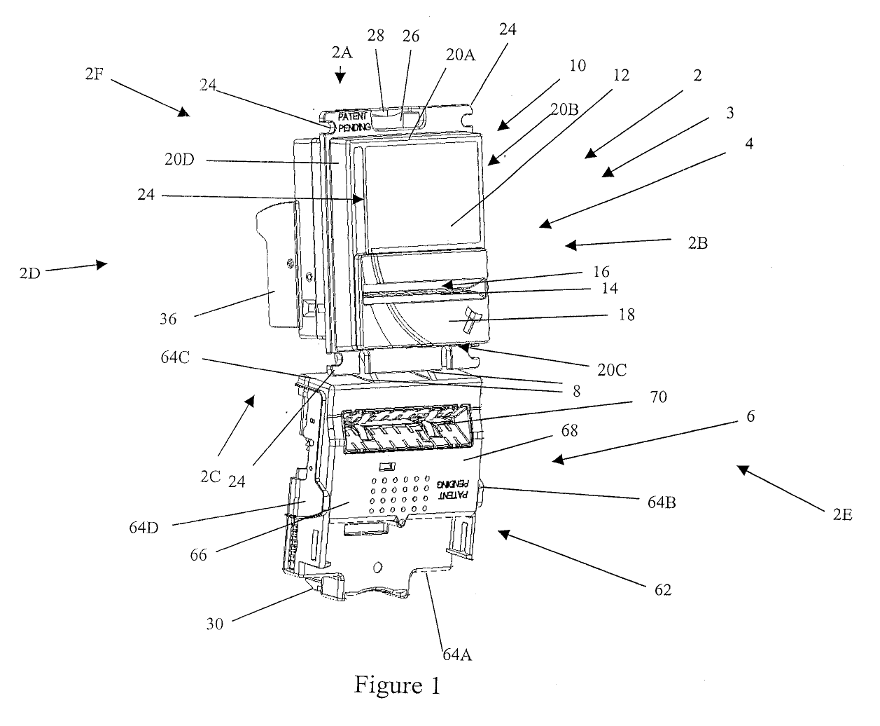

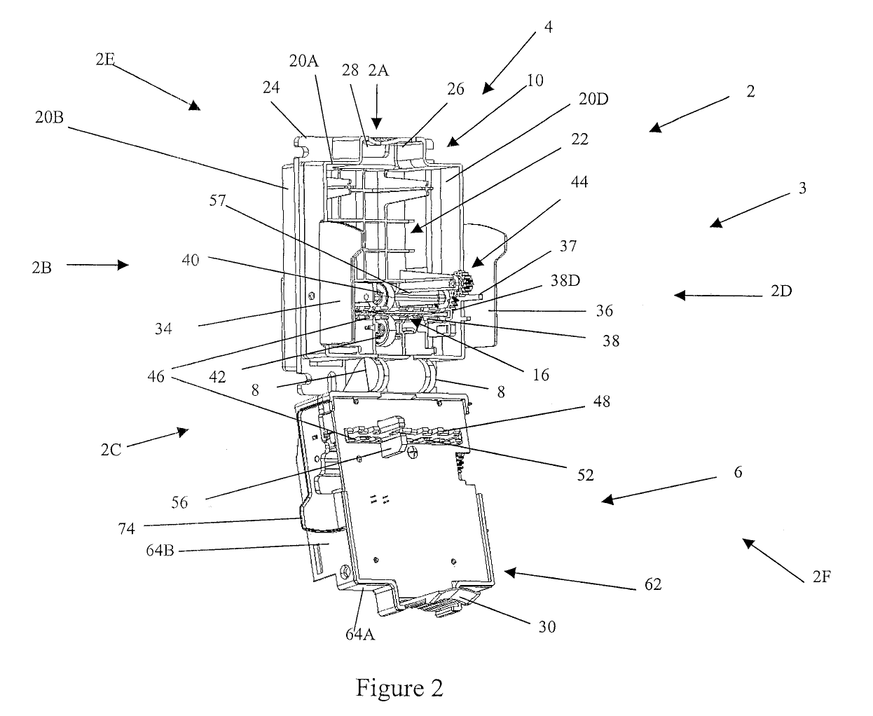

Referring firstly to FIGS. 1 and 2, in a first embodiment of the invention a banknote validator 2 comprises a compact, box-like housing 3 having first, second, third and fourth lateral sides 2A, 2B, 2C, 2D, a proximal end 2E and a distal end 2F. The housing is comprised of components which are moulded from a durable plastics material. Essentially the validator comprises three major moulded modules which are described below.

The banknote validator 2 comprises a banknote receiving portion 4 for receiving banknotes (banknotes not shown), which represents a first major moulded module, and a banknote acceptance portion 6 for validating and dispensing received banknotes to a long term store (not shown), which represents a second major moulded module. The banknote receiving portion 4 and the banknote acceptance portion 6 are pivotally connected together via two hinges 8, as will be explained in detail below. In FIG. 1 and FIG. 2, the validator 2 is shown in an open position, with the banknote acceptance portion 6 pivoted away from the banknote receiving portion 4.

The banknote receiving portion 4 comprises a mask or bezel 10 having an oblong front face 12 best seen in FIG. 1. The front face 12 is proximal, i.e. faces users of the banknote validator 2, and comprises an oblong banknote receiving (or input) slot 14 which defines an opening of a banknote path (or pathway) 16 along which banknotes travel into and within the banknote validator 2 in use. The receiving slot 14 is located in an oblong proximally raised section 18 of the front face 12, so as to be visible and accessible to users when the banknote validator 2 is mounted in a vending machine or the like (not shown). Depending on the design of the vending machine, the raised section 18 of the front face 12 may be the only part of the banknote validator 2 that is visible when the validator 2 is mounted.

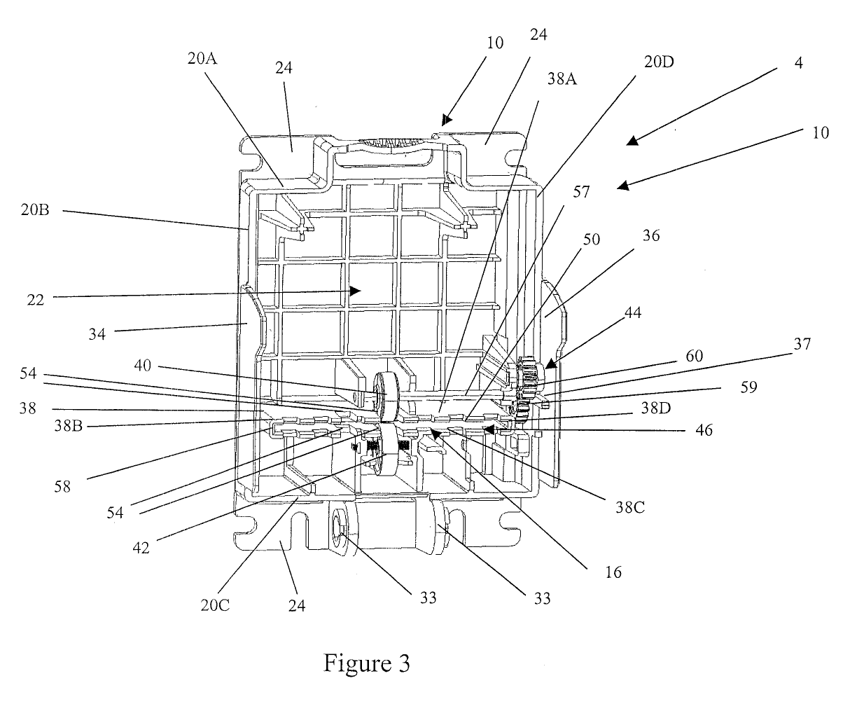

Referring to FIG. 1, FIG. 2 and FIG. 3, first second, third and fourth forward side walls 20A, 20B, 20C, 20D of the bezel 10 respectively extend distally from the oblong front face 12, to give the bezel 10 a distally open, box-like shape having an interior cavity 22. The forward side walls 20A, 20B, 20C, 20D comprise a number of formations 24 for locating and securing the banknote validator 2 during mounting. Additionally, the first side wall 20A comprises a pocket 26 having a slit 28 for engaging a clip 30 of the banknote acceptance portion 6 as will be described later, whilst the third side wall 20C supports two bearings 33, which each form part of one of the hinges 8. The second and fourth side walls 20B, 20D comprise respective outwardly raised flaps 34, 36, that extend distally and aid sealing and location of the receiving portion 4 with respect to the acceptance portion 6 as will be described. The flaps 34, 36 comprise internal locating projections 37.

One function of the bezel 10 is to house internal components of the validator 2 within the banknote receiving portion 4. With reference to FIGS. 2 and 3, the main components that are housed within the bezel 10 of the banknote receiving portion 4 are: a banknote receiving channel 38 defining the banknote path 16 in the banknote receiving portion 4, a pair of drive wheels 40, 42 for gripping and transporting banknotes along the banknote path 16 in use, and a transmission 44 for driving one of the drive wheels 40.

The banknote receiving channel 38 is a rigid tube that is integral with the bezel 10 and extends distally from the receiving slot 14 in the front face 12 of the bezel 10 up to an interface 46 with a banknote acceptance channel 48 of the banknote acceptance portion 6.

The banknote acceptance channel 48 forms the third major moulded module and will be described in detail later. Together the banknote receiving channel 38 and the banknote acceptance channel 48 form an enclosed conduit through the banknote validator, which defines the complete banknote pathway 16 through the validator. The banknote receiving channel 38 is oblong in cross section and has a comparatively great width, defined by the distance between first and second lateral walls 38B, 38D, and a comparatively small height defined by the distance between first and second major walls 38A, 38C. The banknote receiving channel is thus designed to define and encapsulate the banknote path 16 and closely match the dimensions of the banknotes which can be conveyed and guided along the banknote path 16. Whilst the width of the channel 38 is substantially uniform throughout, its height is tapered in the region of the receiving slot 14, decreasing distally from the slot 14, before reaching a constant value, thereby having a funnel-shape. This assists in guiding the insertion of the banknote into the validator.

The lateral walls 38B, 38D of the banknote receiving channel 38, which act as guide surfaces (or guide means) for banknote edges, are seamless between the receiving slot 14 and the interface 46. At the interface 46 the major walls 38A, 38C of the banknote receiving channel 38 comprise jagged (toothed) edges 50 that are arranged to complement and cooperate with associated jagged (toothed) edges 52 of the banknote acceptance channel 48 of the banknote acceptance portion 6. The major walls 38A, 38C of the banknote receiving channel 38 also comprise cut outs 54 provided along the direction of the banknote path for accommodating the wheels 40, 42 and a light guide 56 of the banknote acceptance potion 6, as will be described in detail below. The cut outs 54 for accommodating the light guide 56 are longer than the cut outs 54 accommodating the wheels 40, 42 so that the tip of the light guide 56 is closer to the receiving slot 14 than the nip of the wheels 40, 42. The insertion of a banknote can thus be sensed by the validator 2 via the light guide 56 before the banknote reaches the nip of the wheels 40, 42. The lateral walls 38B 38D of the banknote receiving channel 38 comprise substantially straight edges 58 oriented perpendicularly to the banknote path 16 at the interface 46.

The pair of wheels 40, 42 serve to transport banknotes along the banknote receiving channel 38 in use. The pair 40, 42 comprises a first, drive wheel 40 and a second, idler wheel 42. The first and second wheels 40, 42 are biased towards each other so that they are able to grip banknotes between them. The wheels 40, 42 are provided on spindles (or axles) which are respectively supported by protrusions on the bezel 10, on either side of the banknote receiving channel 38. Each wheel 40, 42 is accommodated by a respective central slit 54 in an associated major wall 38A, 38C of the banknote receiving channel 38. The pair of wheels 40, 42 thus accesses the banknote path 16 centrally at an equal distance from both lateral walls 38B, 38D, to contact the grip banknotes therein. The pair 40, 32 is positioned close to the receiving slot 14 and is thus able to grip and transport banknotes along the banknote path 16 even when they are only partially inserted into the banknote path 16 via the receiving slot 14. Also the provision of a single pair of wheels 40, 42 centrally to the banknote path 16 enable the pair of wheels 40, 42 to act as a pivot point for a gripped banknote which has been inserted at an angle to the correct direction of travel along the banknote path 16. The provision of the pivot point, particularly together with the seamless side walls 38B, 38D of the banknote receiving channel 38 enable correction of such misalignment.

The driven wheel 40 is actuated via the transmission 44. The transmission 44 comprises: an extended axle 57 between the drive wheel 40 and a first cog 59 that is mounted on the fourth forward side wall 20D; and a second cog 60 that is mounted on an associated one of the flaps 36 and is in cooperation with the first cog 59. The second cog 60 extends distally beyond the fourth side wall 20D and is shielded by the flap 36. Driving of the second cog 60 by a drive mechanism 88 (provided in the banknote acceptance portion 6) results in movement of the driven wheel 40, via the first cog 59 and the axle 57.

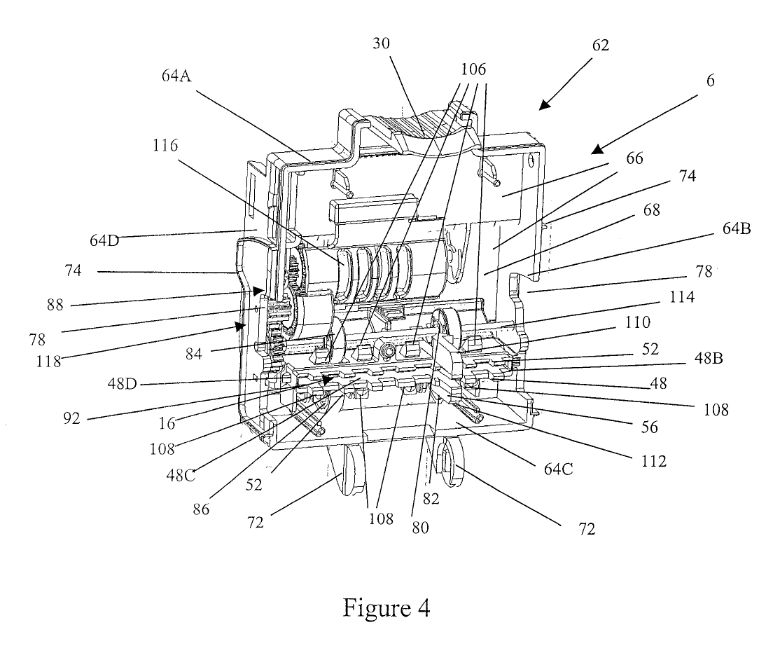

Referring now to FIG. 1, FIG. 2 and FIG. 4, the banknote acceptance portion 6 comprises a case 62 of box-like shape, which is distally open. The case comprises first, second, third and fourth rearward side walls 64A, 64B, 64C, 64D that correspond in plan to, and align with, the distal ends of the forward side walls 20A, 20B, 20C, 20D of the banknote receiving portion 4, and which support a rear plate 66 of the case 62 at their distal ends. The rear plate 66 comprises a distally raised section 68, having a banknote acceptance (or exit) slot 70 that defines an exit of the banknote path 16.

The first rearward side wall 64A comprises the proximally extending clip 30 which is engagable with the slit 28 in the pocket 26 of the first forward side wall 20A in a snap fit.

The third side wall 64C supports first and second posts 72 which are engageable with the bearings 33 of the banknote receiving portion 4 to form the hinges 8. Finally, the second and fourth rear side walls 64B, 64D comprise external ridges 74 for locating the outwardly raised flaps 34, 36 of the banknote receiving portion 4, and indentations 78 for accommodating internal locating projections 37 of the flaps 34, 36 and the second cog 60 of the transmission 44 of the banknote receiving portion 4.

A number of internal components of the banknote validator 2 are held within, or supported by, the case 62 of the banknote acceptance portion 6. These components include: the banknote acceptance channel 48 defining the banknote path 16 within the banknote acceptance portion 6; banknote sensing means for sending and validating banknotes in the banknote path 16; two pairs of wheels 80, 82, 84, 86 for transporting banknotes along the banknote path 16; and a drive mechanism 88 for driving two of the wheels 80, 84 and the second cog 60 of the receiving portion 4.

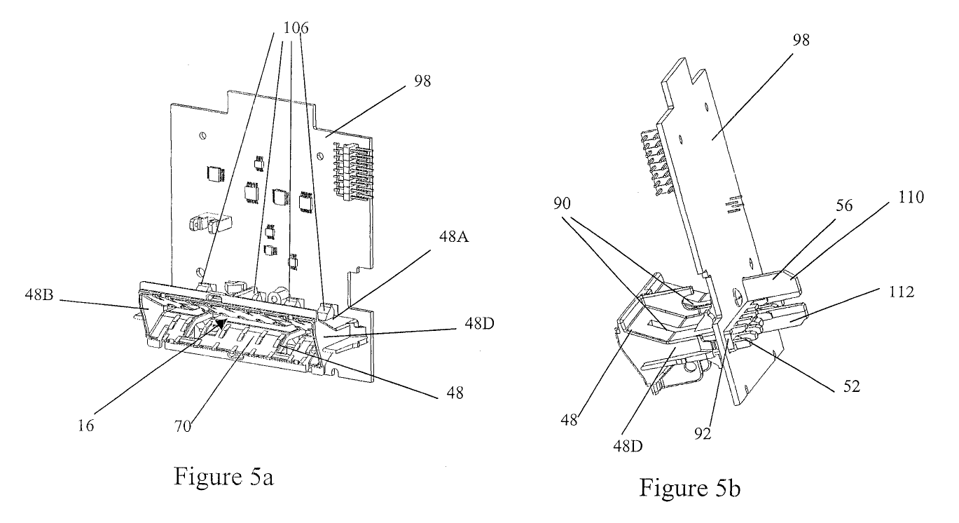

Referring to FIG. 4 and FIGS. 5a and 5b, the banknote acceptance channel 48 mirrors the shape of the banknote receiving channel 38, being a rigid tube that extends proximally from the banknote acceptance slot 70 in the rear plate 66 of the case 62 up to the interface 46 with the banknote receiving channel 38 of the banknote receiving portion 4. The acceptance channel 48 is oblong in cross section and has a comparatively great width, defined by the distance between first and second lateral walls 48B, 48D lying next to the second and fourth rearward side walls 64B, 64D respectively, and a comparatively small height defined by the distance between the first and second major walls 48A, 48C. Whilst the width of the channel 48 is substantially uniform throughout, its height is tapered in the region of the acceptance slot 70, decreasing proximally from the slot 70, before reaching a constant value. The banknote acceptance channel 48 is therefore funnel shaped at one end.

One function of the banknote acceptance channel 48 is to define the banknote path 16 within the banknote acceptance portion 6 and to guide banknotes travelling along the banknote path 16 in use. The lateral walls 48B, 48D of the banknote acceptance channel 48, which acts as guide surfaces for banknote edges, are seamless between the interface 46 and the acceptance slot 70. At the interface 46 the major walls 48A, 48C of the banknote receiving channel 48 comprise jagged (toothed) edges 52 that are arranged to complement and cooperate with associated jagged (toothed) edges 50 of the banknote receiving channel 38 of the banknote receiving portion 4. The major walls 48A, 48C also comprise apertures 90 for accommodating the guide wheels 80, 82, 84, 86 of the acceptance portion 6. The lateral walls 48B, 48D of the banknote acceptance channel 48 comprise substantially straight edges 92 oriented perpendicularly to the banknote path 16 at the interface 46.

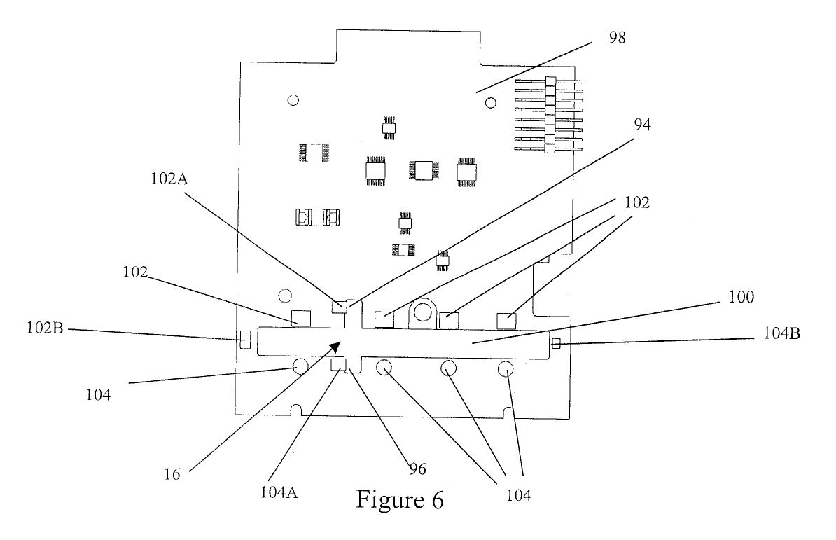

The banknote acceptance channel 48 also plays an important part in the sensing of banknotes by the banknote validator 2. In contrast to the banknote receiving channel 38, the banknote acceptance channel 48 is a translucent moulded object and acts as an integrated optical element that combines with a circuit board 98 to sense the validated banknotes. Referring to FIGS. 5a and 5b, the circuit board 98 is mounted on the banknote acceptance channel 48, substantially perpendicularly to the banknote path 16, near the interface 46 with the banknote receiving portion 4. The banknote acceptance channel 48, and hence the banknote path 16 defined by it, pass through a complementary shaped aperture 100 in the circuit board 98. As is best appreciated from FIG. 6, which shows the circuit board 98 in isolation, the aperture 100 is surrounded by six LED/sensor pairs 102, 102A, 102B, 104, 104A, 104B of the circuit board 98 that each act across the aperture 100, via the banknote acceptance channel 48.

The LEDs 102, 102A, 102B and sensors 104, 104A, 104B are all located on a distal surface of the circuit board 98. To enable banknotes in the banknote path 16 to be sensed by the circuit board 98, the banknote acceptance channel 48 provides a major portion of a respective light path between the or each LED 102, 102A, 102B and sensor 104, 104A, 104B of each pair. The remaining portion of each respective light path comprises a transversal of at least a portion of the banknote path 16. Whilst the banknote acceptance channel 48 holds only a portion of the light paths, it can be said to define the entire light paths.

Four of the LED/sensor pairs 102, 104 of the circuit board are concerned with determining the validity of banknotes and are arranged to act through the banknote path 16, across the height of the banknote channel 48. Each of these validity determining pairs 102, 104 comprises two adjacently mounted LEDs 102. To provide light paths for the four validity determining LED/sensor pairs 102, 104, the banknote acceptance channel 48 comprises: four integral transmitting prisms 106 which respectively steer light from the LEDs 102 of an associated validity determining pair 102, 104 on the circuit board 98, through the first major wall 48A of the banknote acceptance channel 48, into the banknote path 16; and four integral receiving prisms 108, which are oppositely aligned to the transmitting prisms 106 across the banknote path 16, and steer any light from the LEDs that is transmitted in use through a banknote in the banknote path 16 via the second major wall 48C of the banknote acceptance channel 48, to the sensors 104 of the validity determining pairs 102, 104. At an interface of the integral transmitting prisms 106 from the LEDs, a collecting lens is provided for collecting the light generated by a respective LED. Similarly, at an interface surface of the receiving prisms 108 with the sensors, a focussing lens is provided for focussing light onto a corresponding sensor. The circuit board 98 can determine the validity of banknotes in the banknote path 16 by measuring and analysing, in conventional fashion, the light received by the sensors 104 of the four validity determining LED/sensor pairs 102, 104.

A fifth LED/sensor pair 102A, 104A is also arranged to act across the height of the banknote channel 48 and detects the insertion of banknotes into the validator 2. The light path for the fifth LED/sensor pair 102A, 104A, which comprises only a single LED, is provided by the light guide 56. The light guide 56 is integral with the banknote acceptance channel 48 and extends, via slits 94, 96 in the circuit board 98, into the cut outs 54 of the banknote receiving portion 4, beyond the pair of wheels 40, 42 of the receiving portion 4, as discussed above. The light guide 56 comprises elongate transmitting and receiving arms 110, 112 that extend proximally, in alignment with each other from outer surfaces of the first and second major walls 48A, 48C of the banknote acceptance channel 48 respectively, on either side of the banknote path 16. During sensing, light travels from the fifth LED/sensor pair 102A, via an input prism, into the transmitting arm 110. At a proximal end of the transmitting arm 110, the light is deflected across the banknote path 16 and into the corresponding receiving arm 112. Here the light is deflected distally towards an output prism, which steers it to the sensor 104A of the fifth LED/sensor pair 102A, 104A. The circuit board 98 can determine whether or not a banknote has been inserted into the banknote path 16 by measuring and analysing in conventional fashion the light received by the sensor 104A of the fifth LED/sensor pair.

The sixth LED/sensor pair 102B, 104B acts to enhance the security of the banknote validator 2 and is arranged to act across the width of the banknote channel 48. Whilst the LEDs of the five previously described LED/sensor pairs 102, 102A, 104, 14A face distally and require prisms to divert their emitted light into the banknote path 16, the single LED 104B of the sixth sensor pair 102B, 104B is mounted orthogonally to the circuit board 98 and emits light directly into the first lateral wall 48B of the banknote acceptance channel 48. Thus, to provide a light path for the sixth pair 102B, 104B, the acceptance channel 48 comprises an integral condensing lens in its first lateral wall 48B, and a receiving prism in the second lateral wall 48D to divert transmitted light to the distally facing sensor 104B of the pair. The circuit board 98 can help to determine whether or not a fraudster is attempting to defraud the validator by measuring and analysing in conventional fashion the light received by the sensor 104B of the sixth LED/sensor pair.

In summary, the banknote acceptance channel 48, which surrounds and defines the banknote path 16 longitudinally, acts as a single optical element that provides all the necessary light paths for the sensing functions of the validator 2. The banknote acceptance channel 48 is fabricated as a single moulded component having many integrated formations which carry out different functions. Providing these functions in a single component vastly decreases costs over multicomponent solutions.

Whilst banknotes entering the banknote validator are initially conveyed by the pair of wheels 40, 42 of the banknote receiving section 4, the banknote acceptance section comprises two pairs of wheels 80, 82, 84, 86 for conveyance further downstream, as illustrated in FIG. 4. The two pairs of wheels 80, 82, 84, 86 of the banknote acceptance portion 6 are identical in structure to the pair of wheels 40, 42 of the banknote receiving portion 4. They are mounted adjacent to each other, and access the banknote path 16 in the banknote acceptance portion 6, via the apertures 90, to grip and transport banknotes.

Each of the two pairs of wheels 80, 82, 84, 86 comprises a driven wheel 80, 84 and an idler wheel 82, 86 which is spring biased against the driven wheel. The driven wheels 80, 84 are mounted in parallel on an axle 114 forming part of the drive mechanism 88. The drive mechanism 88 additionally comprises a drive motor 116, mounted on the proximal side of the rear plate 66, and a system of cogs 118 operatively connecting the motor 16 and the axle 114.

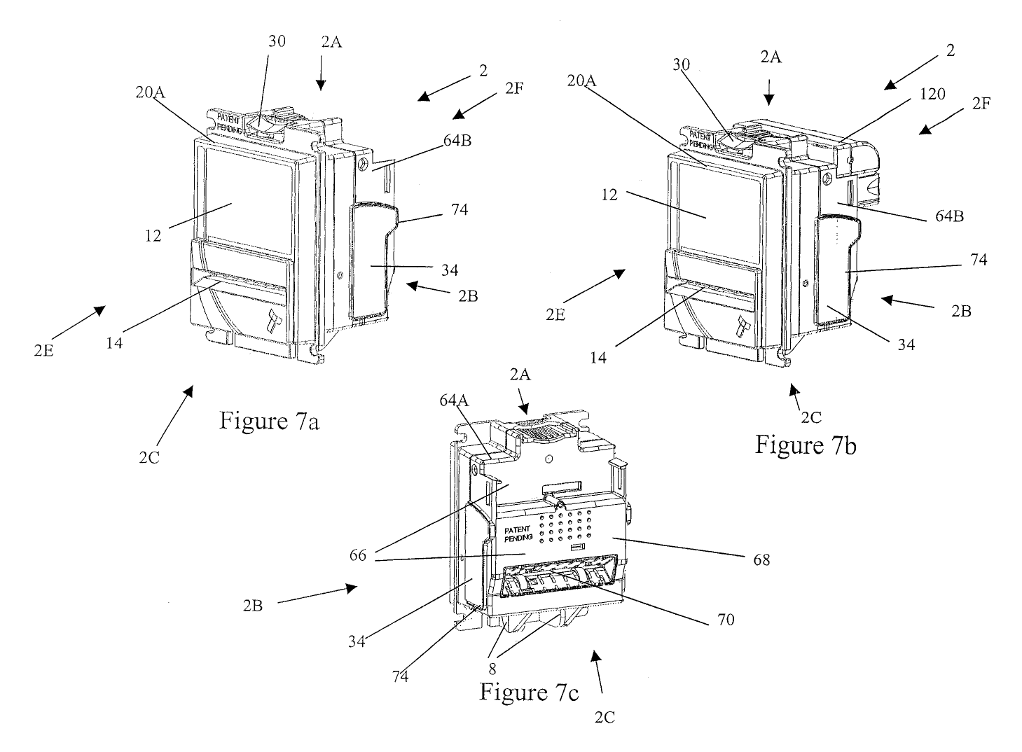

As discussed above, the banknote receiving portion 4 and the banknote acceptance portion 6 are removable pivoted with respect to each other via two hinges 8 formed by bearings 33 on the receiving portion 4 and posts 72 on the acceptance portion 6. Thus the receiving portion 4 and the acceptance portion 6 may be: completely separated from each other as shown in FIG. 3 and FIG. 4, or brought into a pivoted open position as shown in FIG. 1 and FIG. 2, or brought into a pivoted closed position as shown in FIG. 7a to 7c.

In the closed position of FIGS. 7a to 7c, the banknote receiving portion 4 and the banknote acceptance portion 6 engage. Specifically, the hinges 8 hold the portions 4, 6 together at the third side 2C of the validator 2 whilst, at the first side 2A of the validator 2, the clip 30 of the case 62 engages the slit 28 of the bezel 10 in a snap fit. At the second and fourth sides 2B, 2D the raised flaps 34, 36 of the receiving portion 4 surround the second and fourth rearward side walls 64B, 64D of the acceptance portion 6. The flaps 34, 36 are located with the help of the ridges 74, the internal location projections 37 and the indentations 78. Thus, in summary, the bezel 10 and the case 62 combine to form an enclosed chamber for the internal components of the validator 2 in the pivoted closed position.

There is further, internal engagement between the banknote receiving portion 4 and the banknote acceptance portion 6 in the pivotally closed position. The banknote receiving channel 38 and the banknote acceptance channel 48 engage via the jagged (toothed) edges 50, 52 at the interface 46, rendering the banknote path 16 continuous from the receiving slot 14 to the acceptance slot 70. Also by means of this agreement a continuous banknote path defining tube is formed from input to output slot of the validator, with no longitudinal joining seam and therefore this greatly reduces the opportunity for banknote jamming to occur. Further, the light guide 56 and its arms 110, 112 engage with the banknote receiving channel 38, whilst the second cog 60 of the transmission 44 engages with the system of cogs 118 of the drive mechanism 88 to establish an operative connection between the motor 116 and the driven wheel 40 of the receiving portion 4.

Once the banknote receiving portion 4 and the banknote acceptance portion 6 are in full engagement in the closed position, the validator 2 can perform its task of validating banknotes. When a banknote is inserted into the banknote receiving slot 14, the light circuit in the light guide 56 is interrupted. This is detected by the fifth LED/sensor pair 102A, 104A of the circuit board 98 and the motor 116 is powered to rotate the driven wheels 40, 80, 84 of the validator 2, gripping and transporting the banknote downstream, into the banknote receiving channel 38, along the banknote path 16.

The banknote is initially only gripped and transported by the most proximal, centrally positioned pair of wheels 40, 42 in the banknote receiving portion 4. By virtue of its close location to the receiving slot 14, and with the assistance of the seamless lateral walls 38B, 38D of the banknote receiving channel 38, the pair 40, 42 acts to align the banknote correctly in the banknote path 16 before the banknote can make significant downstream progress. Any misalignment of the banknote by the user is corrected by the seamless lateral walls 38B, 38D exerting a correcting force on the banknote and the pivoting movement of the banknote about the centrally positioned pivot wheels 40, 42 in response.

More generally, the fact that the banknote channel 38, 48 contains no seams that are in alignment with the edges of validated banknotes in use, means that the validator 2 is less prone to jamming. This is particularly enabled by the fact that the validator 2 is split into an upstream receiving portion 4 and a downstream acceptance portion 6, between which the lateral walls 38B, 38D of the banknote channel 38, 48 comprise a seam that is misaligned with the direction of banknote travel in use.

Once a banknote has been correctly aligned in the banknote receiving portion 4, it enters the banknote acceptance portion 6 where it is validated by the validation LED/sensor pairs 102, 104 of the circuit board 98 acting through the banknote acceptance channel 48. If the banknote is authenticated, i.e. found to be valid, the motor 116, acting via the two pairs of wheels 80, 82, 84, 86 in the banknote acceptance portion 6, continues to transport the banknote downstream and out of the acceptance slot 70, into the secure long term store. If on the other hand the banknote is not authenticated, i.e. found to be invalid, the motor 116 is reversed and the banknote is returned, upstream, through the banknote receiving slot 14.

If an attempt is made to defraud the validator by attaching a string to a banknote, this is detected by the sixth LED/sensor pair 102B, 104A of the circuit board.

Referring to FIG. 7b, the motor 116 of the banknote validator 2 is powered by an external power supply unit 120 which may be removably mounted on the rear plate 66 of the banknote validator. The removably mounted power supply 120 can thus be easily replaced, for example to enable the validator to work on a different voltage.

The banknote acceptance portion 4 and the banknote receiving portion 6 may also be individually replaced, avoiding, for example, the expensive replacement of the entire validator 2 in classes where there is only cosmetic damage to the bezel 10.

Typically the banknote validator apparatus shown will be used in a conjunction with a collector or stacker mechanism although this is not shown in the drawings for ease of reference. The apparatus can be incorporated within the collector as a combined assembly or can be positioned with respect to a collector or stacker so as to allow the valid banknotes which pass along the banknote path to leave the banknote validator to automatically pass into the collector or stacker. Once in the collector or stacker the banknotes are held therein until the collector or stacker is removed by authorised personnel and then emptied and/or replaced.

The above embodiment of the invention is only exemplary and it will be appreciated that many modifications are possible without departing from the scope of the invention. Thus, for instance, the distribution of components between the banknote receiving portion and the banknote acceptance portion may vary. Further, in an alternative embodiment, seams along the banknote path may be avoided by the provision of a single banknote channel, such as a tube, that extends seamlessly from a receiving slot to an acceptance slot.

1. A banknote validator comprising; a housing having a banknote receiving portion and a banknote acceptance portion; and a banknote path, formed through said portions with said banknote receiving portion defining an upstream section of the banknote path, and the banknote acceptance portion defining a downstream section of the banknote path and wherein the banknote receiving portion and the banknote acceptance portion include seamless banknote guide means forming the banknote path in the respective portions.

2. The banknote validator of claim 1, wherein the banknote guide means are in the form of a receiving tube.

3. The banknote validator of claim 2, wherein the receiving tube in each portion has an interlocking formation for engaging a complementary interlocking formation in the tube in the other of the portions.

4. The banknote validator of claim 1, wherein the banknote receiving portion comprises an input slot and means for gripping and aligning banknotes inserted into the banknote path via said input slot.

5. The banknote validator of claim 4, wherein the means for gripping and aligning banknotes comprise: driving means positioned centrally with respect to a length of the input slot for pivotally gripping and conveying banknotes along the banknote path; and seamless banknote guide means provided at elongate edges of the banknote path for aligning pivotally gripped banknotes within the banknote path.

6. The banknote validator of claim 5, wherein the driving means comprise a pair of driven wheels.

7. The banknote validator of claim 6, wherein at least one of the wheels is driven by a motor located in the banknote acceptance portion.

8. The banknote validator of claims 6 wherein one of the wheels is driven and the other wheel is a reaction wheel.

9. The banknote validator according to claim 5, wherein the banknote receiving portion includes a cut out at the upstream section of the banknote path for allowing the driving means to access the banknote path.

10. The banknote validator according to claim 1, wherein the banknote acceptance portion comprises banknote conveying means and banknote sensing means.

11. The banknote validator of claim 10, wherein the banknote conveying means comprise a drive means for gripping and conveying banknotes and a motor for driving the drive means.

12. The banknote validator according to claim 1, wherein the banknote aligning means of the banknote acceptance portion are arranged to act as an optical element for conveying light from a light source into the banknote path to illuminate a banknote in use.

13. The banknote validator of claim 12, wherein the banknote guide means are arranged to act as an optical element for conveying light from the banknote path to a light sensor.

14. The banknote validator of claim 12, wherein the banknote guide means comprise a translucent plastics material.

15. The banknote validator of any one of claim 12, wherein the banknote guide means comprise an acceptance tube that surrounds the banknote path and is arranged to transmit light across the banknote path.

16. The banknote validator of claim 15, wherein the acceptance tube includes a cut-out for accommodating a drive means.

17. A banknote validator according to claim 1 wherein an electronic circuit board is provided with banknote sensing means; wherein the banknote path is arranged to intersect a major plane of the circuit board.

18. A banknote validator according to claim 17 wherein the banknote path passes through an aperture in the circuit board.

19. The banknote validator of claim 1, wherein the validator includes a circuit board includes a validity LED/sensor pair for sensing the validity of banknotes in the banknote path, and wherein the banknote guide means defines a validation light path between an LED and a sensor of the validator LED/sensor pair, the validation light path intersecting with the banknote path.

20. The banknote validator of claim 19, wherein the banknote guide means comprises one or more integral optical formations for guiding light along the validation light path.

21. The banknote validator of claim 20, wherein the LED and the sensor of the validity LED/sensor pair are both located on a single major surface of the electronic circuit board and wherein the integral optical formations of the banknote guide means comprise a plurality of prisms for steering light from the LED of the validity LED/sensor pair, across the banknote path, to the sensor of the validity LED/sensor pair.

22. The banknote validator of claim 21, wherein the integral optical formations of the banknote guide means further comprise a collecting lens for focussing light on the sensor of the validity LED/sensor pair.

23. The banknote validator of claim 17, wherein the electronic circuit board comprises an insertion LED/sensor pair for sensing the insertion of banknotes into the banknote validator; and the banknote guide means defines an insertion light path between an LED and a sensor of the insertion LED/sensor pair, the insertion light path intersecting with the banknote path.

24. The banknote validator of claim 19, wherein the banknote guide means comprise an insertion light guide which steers light from the LED of the insertion LED/sensor pair, across the upstream section of the banknote path defined by the banknote receiving portion of the validator, to the sensor of the insertion LED/sensor pair.

25. The banknote validator of claim 24, wherein the banknote receiving portion comprises an input slot and drive means for gripping and transporting banknotes inserted into the banknote path via said input slot, and wherein the insertion light guide is arranged to steer light across the upstream section of the banknote path at a position between the drive means and the input slot.

26. The banknote validator of claim 25, wherein the insertion light guide comprises a light transmitting arm and a light receiving arm and wherein the light transmitting arm and the light receiving arm are arranged to cooperate with the banknote receiving portion.

27. The banknote validator of any claim 19, wherein the integral optical formations further comprise a collecting lens for focussing light on the sensor of the insertion LED/sensor pair.

28. The banknote validator of claim 19, wherein: the electronic circuit board comprises an anti-stringing light path between an LED and a sensor of the anti-stringing LED/sensor pair, the anti-stringing light path intersecting with the banknote path.

29. The banknote validator of claim 19 wherein the anti-stringing light path and the validation light path are oriented transversely with respect to each other within the banknote path.

30. The banknote validator of claim 28, wherein the banknote guide means comprises a collecting lens for focussing light on the sensor of the anti-stringing LED/sensor pair.

31. The banknote validator of claim 1, wherein the banknote acceptance portion and the banknote receiving portion are pivotably attached to each other.

32. The banknote validator of claim 1, wherein the banknote acceptance portion and the banknote receiving portion are removably attached to each other.

33. The banknote valuator of claim 1, wherein the banknote acceptance portion and the banknote receiving portion comprise complementary interlocking moulded formations for releasably interlocking the banknote acceptance portion and the banknote receiving portion.

34. A banknote validator according to claim 18 wherein the aperture is located so as to form part of the banknote path.

35. A banknote validator according to claim 34 wherein the banknote, when moving along the path, passes through the aperture in the circuit board.

36. A banknote validator according to claim 1 wherein the validator includes an optical elements and the banknote path passes through an aperture in the optical element.

37. A banknote validator according to claim 1 wherein the validator includes a bezel comprising a banknote receiving slot for receiving a banknote within the banknote validator in use, a single pair of banknote gripping wheels positioned centrally along the slot to enable pivoting movement of the received banknote in use and at least one seamless guide surface for lining the pivoted banknotes within the slot.

38. A banknote validator according to claim 36 wherein the bezel aligns banknotes before they proceed downstream.

39. A banknote validator according to claim 1 wherein the banknote, having passed along the banknote path, and having being validated, is allowed to fall into a collector.

40. A banknote validator according to claim 1 wherein the banknote, having passed along the banknote path, and having being validated, is moved into a stacker mechanism in which a plurality of validated banknotes are stacked for subsequent storage.

41. A banknote validator comprising a housing, a banknote path and a circuit board comprising the banknote sensing means, wherein the banknote path is arranged to intersect a major plane of the circuit board.

42. A banknote validator according to claim 41 wherein the banknote, when moving along the banknote path, passes through an aperture in the circuit board.

43. A banknote validator comprising a banknote path and an optical element for sensing the validity of a banknote, wherein the banknote path passes through an aperture in the optical element.

44. A banknote validator having a bezel comprising a banknote receiving slot for receiving a banknote within the banknote validator in use, a single pair of banknote gripping wheels positioned centrally along the slot to enable pivoting movement of the received banknote in use and at least one seamless guide surface for aligning the pivoted banknotes within the slot.
